(19) United States
(12) Patent Application Publication
(10) Pub. No.: US 2014/0240643 A1
(43) Pub. Date: Aug. 28, 2014

(54) THERMAL DESIGN FOR HIGH OUTPUT LED BACKLIGHTS

(71) Applicants: Kevin Joseph Hathaway, Saratoga, CA (US); Thomas Credelle, Morgan Hill, CA (US)

(72) Inventors: Kevin Joseph Hathaway, Saratoga, CA (US); Thomas Credelle, Morgan Hill, CA (US)

(21) Appl. No.: 14/187,294

(22) Filed: Feb. 23, 2014

Related U.S. Application Data
(60) Provisional application No. 61/768,337, filed on Feb. 22, 2013.

(51) Int. Cl. F21V 8/00

(52) U.S. Cl. CPC G02B 6/0085
USPC 349/69

(57) ABSTRACT

The present disclosure includes a LED illuminator that improves heat conduction through a LCD module's rear cover. The disclosed LED illuminator integrates a heat dissipation device for reducing thermal spikes on the LCD glass and in the LED packages by dissipating heat generated within the LCD module. The LED illuminator is built on a metal heat sink, typically made of copper or aluminum, that includes thermal fins along its length which protrude through the LCD module's rear cover for coupling heat into a heat dissipating portion of the improved LCD module.

### CLAIM OF PROVISIONAL APPLICATION RIGHTS

This patent application claims the benefit of U.S. Provision Patent Application No. 61/768,377 filed on Feb. 22, 2013.

### BACKGROUND

1. Technical Field

The present disclosure relates generally to screen backlighting modules that use light emitting diodes (“LEDs”) for illumination and, more particularly, to dissipating the heat generated by the LED illuminator(s).

2. Background Art

LED light sources have been rapidly adopted for backlighting liquid crystal display (“LED”) modules. Presently, LEDs have almost completely replaced mini fluorescent lamps as the preferred light source for LCD backlighting. There are two basic approaches to backlighting an LCD panel, edge lighting and rear lighting. The present disclosure relates primarily to edge lighting configurations. In an edge lit backlight system the light source is located along one or more edges of a thin plastic light guide which uniformly distributes the light from the light sources across the hack of the LCD panel. Therefore, an illuminator in an edge lit backlight is made in the form of a long narrow strip.

There is continued market pressure to make electronic display modules thinner, lighter, more efficient, lower cost and with a narrower inactive border or bezel surrounding the LCD panel. Therefore, as commercial LED based backlighting system designs have evolved, the LED strip illuminator has also become thinner and has been positioned as near as possible to a bottom edge of the rear metal cover of the LCD module. In the design limit, the LED strip illuminator has been mounted directly into one (or more) edge(s) of the rear metal case of the display module. This effectively makes the rear metal case the primary heat dissipating element of an LED edge lit LCD module.

But, as previously mentioned, there is great market pressure to minimize thickness, weight and cost in. LCD modules. LCD module manufactures usually employ the fewest number of LEDs required to achieve the specified display screen brightness together with the thinnest rear case metal necessary for the LEDs to meet the specified display operating life.

An LED's average operating temperature is the primary factor affecting their brightness maintenance (i.e. their effective lifetime). Therefore, the thickness of the metal case and the metal composition both have a significant influence on the display module's ability to dissipate heat. The two most commonly used metals for the rear case are aluminum and steel, with the typical metal thickness ranging from about 0.3 mm to about 1.0 mm. Because the rear case metal is often made so thin, it exhibits a limited ability to conduct and spread heat.

If the objective is to boost the screen brightness of a commercial LCD module, it isn't feasible to increase the number of LEDs in the existing strip illuminator and/or the power handling capacity of the LED packages used in the strip to significantly increase brightness. Significantly increasing the display screen brightness almost always requires increasing an LED strip's power consumption. Increasing power consumed by the LED illuminator results in overheating problems both for the LCD panel, and particularly for the LED strip illuminator. Therefore, an improved means for removing and/or spreading more heat would be advantageous.

Typically, the rear case, the front bezel and the internal plastic frame of an LCD module integrate mechanical catches along their edges which, when the parts are assembled, lock the system together. If these locking features are removed or mechanically compromised the display module cannot be reassembled conveniently.

The present disclosure offers a very effective means for conducting heat away from the LED packages and out of the LCD module case so the heat can be spread and dissipated into the ambient environment.

BRIEF SUMMARY

An object of the present disclosure extending heat coupling features of a metal heat sink out the rear cover of an LCD module along the lighted length of the case which lack locking features.

An object of the present disclosure is to significantly increase an LED illuminator's power density.

An object of the present disclosure is to significantly increase an LED illuminator's power density while maintaining LED effective lifetime.

An object of the present disclosure is to increase an LED illuminator's power density as much as 3-5 times more than a conventional LED illuminator used in commercial LCD modules.

An object of the present disclosure is to increase an LED illuminator's power density as much as 3-5 times more than a conventional LED illuminator used in commercial LCD modules while maintaining LED effective lifetime.

An improved LED strip illuminator is described for an edge lit LCD module that exhibits better heat spreading capability so higher brightness can be achieved without overheating the LEDs and the LCD panel. The improved LED strip illuminator is installed in a commercial LCD module without affecting the module integrity. Embodiments of the disclosure comprise an metallic LED strip illuminator with protruding thermal fins that extend through slots cut through the LCD module's rear cover. Gaps in the heat sink create what appear to be inline fins. A heat sink or other heat spreading device is attached to the thermal fins to conduct heat away from the LEDs thereby extending LED lifetime.

The present invention is somewhat reminiscent of the fins of a Stegosaurus which are thought to have performed a heat regulating function for the dinosaur. Consequently we call this the StegoTherm™ backlighting system.

### BRIEF DESCRIPTION OF THE DRAWINGS

FIG. 1 is a perspective view of an LED strip illuminator.

FIG. 2 is a perspective view of an LCD module's rear metal cover with added slots

FIG. 3a is a perspective view of the LED strip illuminator depicted in FIG. 1 extending through the LCD module's rear metal cover depicted in FIG. 2.

FIG. 3b is a side view of an input section of the LCD module showing the LED strip illuminator.

FIG. 4 is a perspective view of a thermo-mechanical coupler adjacent to the LCD module's rear metal cover and attached to the LED strip illuminator.

FIG. 5 is a perspective view of the thermo-mechanical coupler depicted in FIG. 4 together with a thermal heat spreading element adjacent to the rear metal cover and attached to the LED strip illuminator.

FIG. 6 is a perspective view of the thermo-mechanical coupler and thermal heat spreading element depicted in FIG. 5 together with an adhesive layer.

FIG. 7 is a perspective view of an alternate embodiment finned LED strip illuminator together with an alternative embodiment thermo-mechanical coupler.

FIG. 8 is a perspective view of the alternate embodiment finned LED strip illuminator and thermo-mechanical coupler depicted in FIG. 7 together with a thermal heat spreading element attached to the LCD module's rear metal cover.

### DETAILED DESCRIPTION

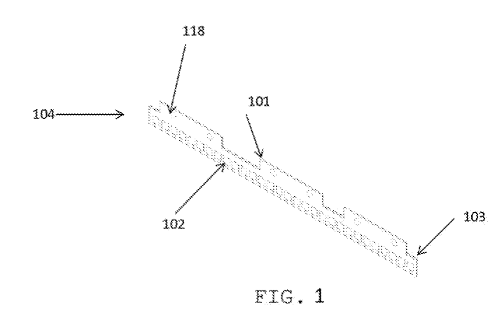

The present invention includes an LED strip illuminator most commonly fabricated on a thermally conductive metal substrate of copper or aluminum. Printed circuit boards (PCBs) fabricated directly on a metallic sheet are commercially available and are known as metal core PCBs. FIG. 1 depicts a LED strip illuminator 104 that preferably includes a metal core printed circuit board (PCB) 103. LEDs 102 are mounted in a linear array on the PCB 103. The PCB 103 includes thermal fins 101. Typically, the metal core PCB 103 is approximately 0.5 mm to approximately 3.0 mm thick.

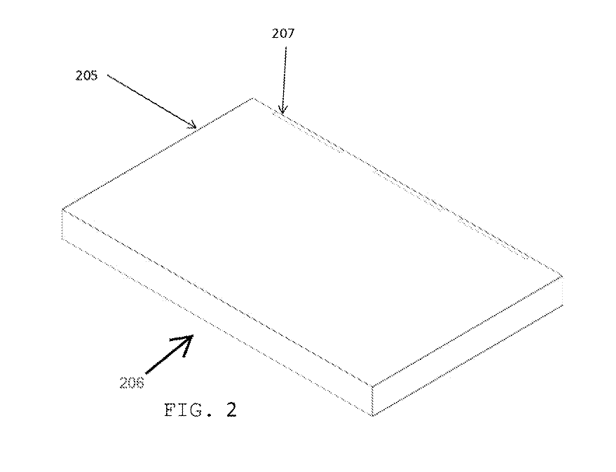

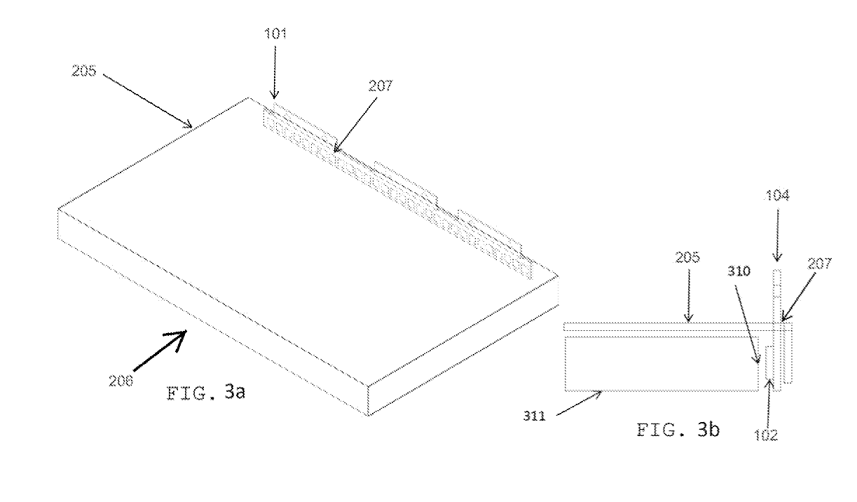

FIG. 2 depicts a rear cover 205 of a LCD module 206 having slots 207 formed therethrough. The locations for the slots 207 are chosen to preserve the LCD module's mounting system such as tabs, screws, and the like. As shown in FIG. 3a, the illuminator fins 101 are inserted into the slots 207 during assembly of the LED strip illuminator 104 into the LCD module 206. The rear cover 205 is not cut near its tooled interlocking features along its outer edge so as to preserve the mechanical integrity of the LCD module 206. FIG. 3b shows a cross section of the input section of the LCD module 206. The LEDs 102 are aligned next to a light guide 311 and the thermal fins 101 of the LED strip illuminator 104 protrude through the slots 207 of the rear cover 205. The fins 101 of the LED strip illuminator 104 are configured so that the LEDs 104 are properly aligned with the light guide 311 when the fins 101 are inserted into the slots 207 of the rear over 205.

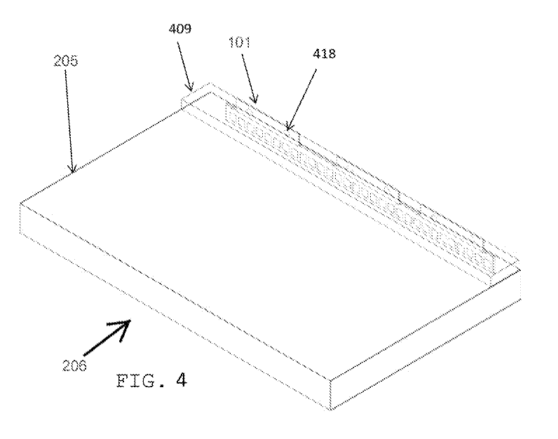

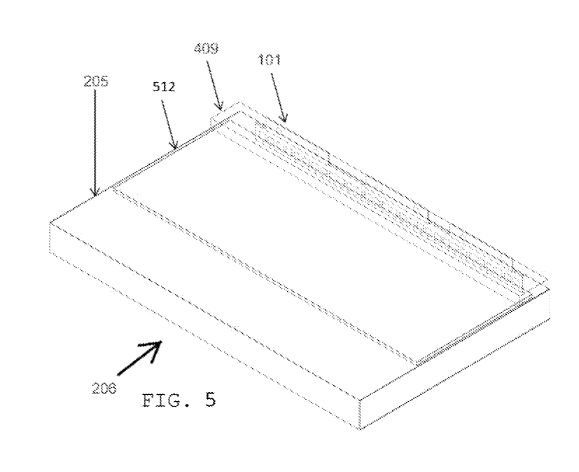

FIG. 4 depicts holes 418 drilled through the thermal fins 101 so the LCD strip illuminator 104 can be mechanically and thermally fastened to a heat coupling element 409 (called the thermo-mechanical coupler or abbreviated to “TMC”) or to an external heat sink. FIG. 5 shows the preferred embodiment of the invention wherein the thermal fins 101 of the LCD strip illuminator 104 are fastened to the TMC 409 which is mounted outside rear cover 205 via a high bond adhesive strip or other attachment means. The adhesive strip is specified to be approximately the same thickness as the next element in the assembly, a thermal spreader 512 depicted in FIG. 5.

In a preferred embodiment of the invention, the thermal spreader 512 is a die-cut graphite sheet, such as is manufactured by Graftech, which includes a thin adhesive layer on the bottom allowing the sheet to be mounted on the outside of the rear cover 205. Of course, there are numerous other thermally conductive sheet materials which could be used for making the thermal spreader 512 including aluminum and copper. A graphite thermal spreader sheet has the advantage that it can be made more thermally conductive than copper but it is lighter than aluminum.

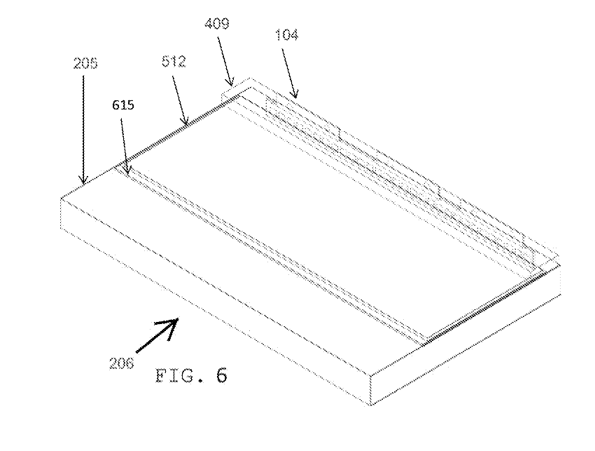

The thermal spreader 512 is positioned so the TMC 409 overlaps it enough to allow very good heat transfer from the TMC 409 into the thermal spreader 512. This is particularly important for graphite thermal spreaders because their transverse thermal conductivity is often as much as two orders of magnitude lower than their in-plane thermal conductivity. Therefore, to achieve a good transfer of heat from the TMC 409 into the thermal spreader 512, there must be a significant surface area at the interface region between them. FIG. 6 shows an example of an adhesive layer 615 used to attach the thermal spreader 512 to the rear cover 205.

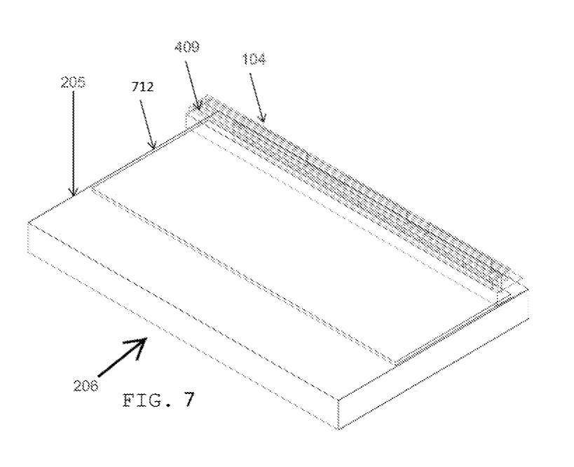

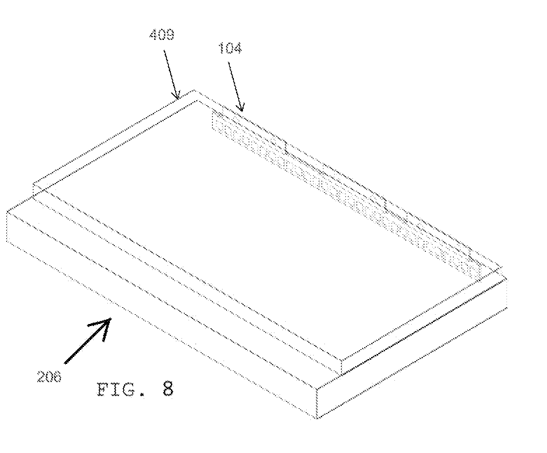

FIG. 7 shows an alternate embodiment where the TMC 409 is replaced with a more conventional finned heat sink 709 that has a relatively thick base, generally in the range of about 3.0 mm. Optionally, the alternative embodiment depicted in FIG. 7 can also include the thermal spreader 512. In a third embodiment depicted in FIG. 8 a metal plate 809 replaces the finned heat sink 709.

While it is convenient to produce the LED strip illuminator 104 on a metal core PCB 103, it is also possible to produce the LED strip illuminator 104 on a more conventional substrate material such as FR4 and then laminate this substrate onto a separately fabricated metal plate.

It is quite feasible to design and fabricate a new LCD module 206 rear cover 205 that includes slots along the illuminator edge (see FIGS. 3a & 3b). But, unless the anticipated production volume of LCD modules 205 is quite large, it is generally more cost efficient to reuse the original rear cover 205 and cut the slots 207 into that part.

Sometimes, a number of small screws are also included in the LCD module 206 to increase mechanical robustness.

Although the present invention has been described in terms of the presently preferred embodiment, it is to be understood that such disclosure is purely illustrative and is not to be interpreted as limiting. Consequently, without departing from the spirit and scope of the disclosure, various alterations, modifications, and/or alternative applications will, no doubt, be suggested to those skilled in the art after having read the preceding disclosure. Accordingly, it is intended that the following claims be interpreted as encompassing all alterations, modifications, or alternative applications as fall within the true spirit and scope of the disclosure including equivalents thereof. In effecting the preceding intent, the following claims shall:
1. not invoke paragraph 6 of 35 U.S.C. §112 as it exists on the date of filing hereof unless the phrase “means for” appears expressly in the claim's text;
2. omit all elements, steps, or functions not expressly appearing therein unless the element, step or function is expressly described as “essential” or “critical;”
3. not be limited by any other aspect of the present disclosure which does not appear explicitly in the claim's text unless the element, step or function is expressly described as “essential” or “critical;” and
4. when including the transition word “comprises” or “comprising” or any variation thereof, encompass a non-exclusive inclusion, such that a claim which encompasses a process, method, article, or apparatus that comprises a list of steps or elements includes not only those steps or elements but may include other steps or elements not expressly or inherently included in the claim's text.

What is claimed is:

1. A liquid crystal display (“LCD”) module that includes a rear cover having slots formed therethrough, the LCD module comprising:
a. a light emitting diode (“LED”) strip illuminator having:
i. LEDs mounted thereon; and
ii. thermal fins that extend through the slots formed through the rear cover of the LCD module;
b. a thermo-mechanical coupler:
i. located outside the LCD module; and
ii. attached to the thermal fins; and
c. a heat diffusing element for spreading the heat away from the LED strip illuminator that is selected from a group consisting of:
i. a thermal spreader;
ii. a finned heat sink; and
iii. a metal plate.
